(19) United States
(12) Patent Application Publication
(10) Pub. No.: US 2013/0033139 A1
(43) Pub. Date: Feb. 7, 2013

(54) Method of Securing a Sealing Device to a Housing with a Limited Bore Diameter

(71) Applicants: Christopher E. Tones, Palmyra, NY (US); Earl Rogalski, Walworth, NY (US)

(72) Inventors: Christopher E. Tones, Palmyra, NY (US); Earl Rogalski, Walworth, NY (US)

(73) Assignee: GARLOCK SEALING TECHNOLOGIES, LLC, Palmyra, NY (US)

(21) Appl. No.: 13/370,909

(22) Filed: Feb. 10, 2012

Related U.S. Application Data
(60) Provisional application No. 61/513,966, filed on Aug. 1, 2011.

(51) Int. Cl. H02K 5/16; H02K 15/00; B32B 38/16; B32B 37/14; B32B 37/12

(52) U.S. Cl. 310/90; 156/60; 156/281; 29/596

(57) ABSTRACT

An apparatus including a seal and a grounding ring along with methods for securing such an apparatus to the housing of a motor. The apparatus comprises an electrically conductive stator including a groove formed in a face thereof. A rotor mates with the stator, wherein the rotor includes a seal groove formed around an inner radius thereof and further comprising a rotor seal disposed in the seal groove. A seal ring is interposed between the stator and the rotor. The stator engages the seal ring around an inner circumference of the seal ring and the rotor engages the seal ring around an outer circumference of the seal ring. A grounding ring is interposed between the stator and the rotor, wherein the grounding ring is electrically coupled to the stator. An electrically conductive adhesive is included for application into the groove and onto the face.

The application claims priority to U.S. Provisional Patent Application Ser. No. 61/513,966, filed Aug. 1, 2011, which is incorporated herein as if set out in full.

### BACKGROUND

The use of seals, either contact or labyrinth seals, is required to retain lubrication in a bearing cavity, exclude contamination from the hearing cavity, and sometimes both tasks at once. In many instances, there is not an existing counter bore in which to install a sealing device. Furthermore, many bore housings are not originally designed with enough material adjacent the shaft bearings to cut a counter bore large enough to accommodate a sealing device.

Accordingly, there is a need for a method of securing a sealing device to an existing bore housing that has a limited bore area around the shaft bearings. There is a further need for a seal that can be secured to an existing motor housing that protects motor bearings from lubricant loss and sometimes from electrical damage.

### SUMMARY

Described herein are various exemplary embodiments of an apparatus including a standard contact lip seal as well as a seal with a grounding ring along with methods for securing such an apparatus to the housing of a motor, for example. The apparatus comprises either a lip seal case or an electrically conductive stator including a groove formed in a face thereof. The groove is selected from one of a square groove, a dovetail groove, and a half dovetail groove. With the labyrinth seal, a rotor mates with the stator, wherein the rotor includes a seal groove formed around an inner radius thereof and further comprising a rotor seal disposed in the seal groove. With the labyrinth seal, a seal ring is interposed between the stator and the rotor wherein the stator may engage the seal ring around an inner circumference of the seal ring and the rotor may engage the seal ring around an outer circumference of the seal ring. With the labyrinth seal, a grounding ring can be interposed between the stator and the rotor, wherein the grounding ring is electrically coupled to the stator. An adhesive (electrically conductive adhesive if required for a shaft grounding application) is included for application into the groove and onto the face. The adhesive may be, for example, an electrically conductive two-part epoxy.

Also contemplated is a motor having a housing and a shaft. The motor includes an electrically conductive stator including a groove formed in a face thereof that is attached to the housing around the shaft. The stator may be attached to the motor with an electrically conductive adhesive disposed in the groove and on the face. A rotor is disposed on the shaft and mated with the stator, wherein the rotor includes a seal groove formed around an inner radius thereof and further comprising a rotor seal disposed in the seal groove and adjacent the shaft. A seal ring is interposed between the stator and the rotor. A grounding ring is interposed between the stator and the rotor, wherein the grounding ring is electrically coupled to the stator and the shaft.

A method of securing a seal to a housing is also contemplated. The method comprises providing a seal having a groove formed in a face thereof, applying adhesive into the groove and onto the face, and placing the face against the housing. The adhesive may be electrically conductive. The seal may also include an isolator ring and may be a labyrinth seal. The method may include cleaning the housing prior to placing the face against the housing.

Another method is contemplated for providing a seal between a housing and a shaft. This method includes providing a stator having a groove formed in a face thereof, applying adhesive into the groove and onto the face, installing the stator around the shaft and placing the face against the housing, engaging a seal ring into the stator, and mating a rotor with the stator such that the rotor engages the seal ring. The method may further comprise installing a rotor seal around the inner radius of the rotor. The step of engaging a seal ring into the stator may he performed before placing the face against the housing. The step of mating the rotor with the stator may be performed before placing the face against the housing. The method may further comprise cleaning the housing prior to placing the face against the housing. The method may further comprise further comprising installing a grounding ring between the stator and the shaft.

The foregoing and other features, utilities, and advantages of the apparatus and methods will be apparent from the following more particular description of the exemplary embodiments as illustrated in the accompanying drawings.

### BRIEF DESCRIPTION OF THE DRAWINGS

The accompanying drawings, which are incorporated in and constitute a part of this specification, illustrate embodiments of an apparatus including a seal and a grounding ring and together with the description, serve to explain the principles and operation thereof. Like items in the drawings are generally referred to using the same numerical reference.

FIG. 1 is aside view in cross-section of the seal assembly according to a first exemplary embodiment;

FIG. 2 is a side view in cross-section of the stator ring as shown in FIG. 1;

FIG. 3 is a side view in cross-section of the rotor ring as shown in FIG. 1;

FIG. 4 is a side view in cross-section of a seal assembly according to a second exemplary embodiment;

FIG. 5 is a side view in cross-section of a seal assembly according to a third exemplary embodiment;

FIGS. 6A-6D are side views in cross-section of seal assemblies according to fourth-seventh embodiments illustrating a lip seal.

### DETAILED DESCRIPTION

Described herein are various exemplary embodiments of an apparatus including a sealing device along with methods for securing such an apparatus to the housing of a motor. Also described herein is a combination seal and grounding ring that protects motor bearings from electrical damage as well as from lubricant loss and contamination.

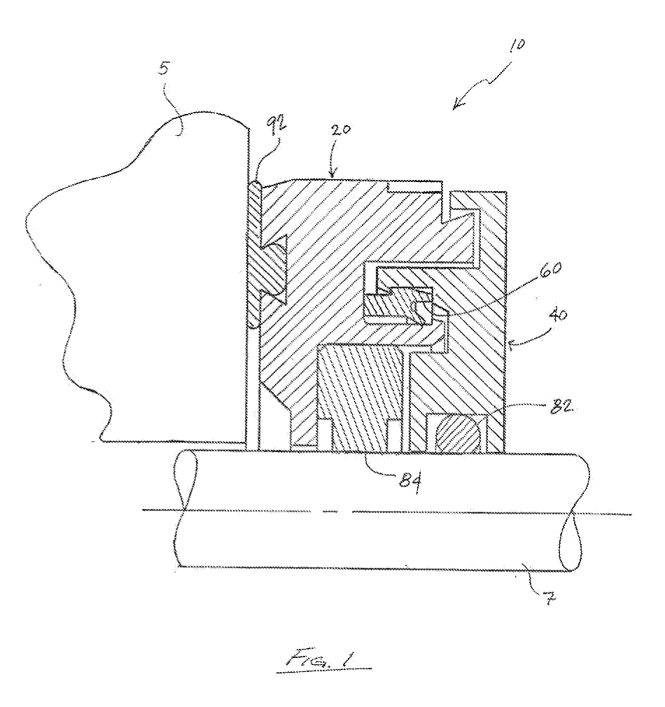

In a first embodiment, shown in FIG. 1, a combination seal and grounding ring assembly 10 includes a stator 20 which is attached to a housing 5 with electrically conductive adhesive 92. The seal assembly 10 also includes a rotor 40 which is sealed to shaft 7 by an O-ring 82. The rotor is connected to the stator 20 via seal ring 60 which is captured between the rotor 40 and stator 20. Accordingly, rotor 40 rotates along with shaft 7 while stator 20 remains stationary with respect to housing 5. A grounding ring 84 is disposed between stator 20 and rotor 40. The grounding ring 84 is electrically conductive and is electrically coupled to both the shaft 7 and the stator 20, thereby providing a safe ground path back to housing 5 for any voltage induced on the shaft.

An electrically conductive adhesive 92 electrically couples the stator 20 to housing 5. As shown in FIG. 2, stator 20 includes a bond groove 22 formed in an axial face 23 of the stator. The bond groove 22, in this case, is a dovetail groove which is adapted to receive a quantity of the adhesive 92. The adhesive 92 curing in the groove 22 provides a more secure connection to avoid or at least inhibit separation of the stator 20 and the housing 5 which could result in arcing. The stator 20 has an outer radius 34 and an inner radius 36. An axial groove 28 is formed in stator 20 opposite axial face 23 and generally opposite bond groove 22 and is bordered by a ring portion 30. The ring portion 30 includes a lip or barb 32. The axial groove 28 is sized and adapted to receive a seal ring 60, which is retained in the axial groove 28 by barb 32. The stator 20 also includes a counter bore 26 that is sized and configured to receive the grounding ring 84.

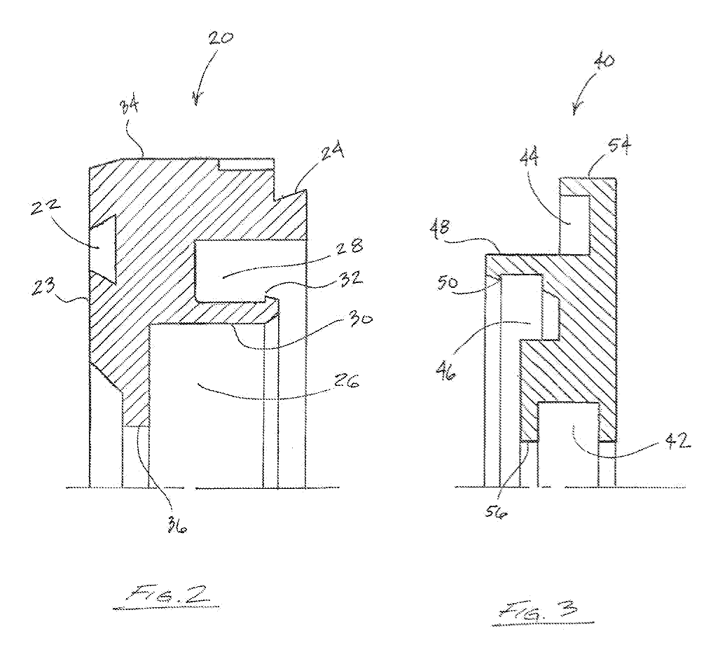

With reference to FIG. 3, the rotor 40 has an outer radius 54 and an inner radius 56. The inner radius 56 is generally smaller than the inner radius 36. A radial groove 42 is formed around the inner radius 56. The groove 42 is sized and adapted to receive an O-ring 82 for sealing against the shaft 7. The rotor 40 also includes an axial groove 46 that is bordered on one side by a ring portion 48, which includes a lip or barb 50. The rotor 40 is retained on seal ring 60 by barb 50.

As can be appreciated, the ring position 30 of the stator 20 extends into axial groove 46 of the rotor 40. The ring position 48 of the rotor extends into axial groove 78 of the stator 20 such that barbs 32 and 50 reside on generally opposite sides of a seal chamber. Moreover, the barbs 32 and 50 have oppositely facing surfaces to retain the seal 60 in the chamber formed. Thus, the rotor 40 is attached to the stator 20 by the seal ring 60. Returning briefly to FIG. 1, it can be appreciated that the stator ring portion 30 and the rotor ring portion 48 create a seal chamber in which the seal, ring 60 resides. Accordingly, the rotor 40 can rotate with respect to the stator 20, and the seal ring 60 seals the stator 20 to the rotor 40. It also can be appreciated in the figures that grounding ring 84 is captured between the stator 20 and the rotor 40 in the counter bore 26.

In addition to the seal ring 60, the stator-rotor assembly also provides a labyrinth seal between the shaft 7 and the housing 5. As shown in FIG. 2, the stator 20 includes a protrusion ring 24 that engages an axial labyrinth groove 44 formed in rotor 40. Again, with reference to FIG. 1, the combination of the protrusion 24 engaged with the labyrinth groove 44 creates a labyrinth path through which contaminants or liquids must travel before they reach the seal ring 60. The seal ring 60 may be made of any suitable material such as materials known in the art for manufacturing O-rings, for example. Similarly, the O-ring 82 may be formed out of natural rubber, nitrile, fluorosilicone, to name a few.

With reference to FIG. 1, it can be appreciated that a grounding path is provided between the shaft 7 and the housing 5 through the grounding ring 84, which is in electrical contact with the stator 20, which in turn is in electrical contact with the housing 5 via the electrically conductive adhesive 92. The grounding ring 84 is comprised of an electrically conductive material such as copper, bronze, steel, carbon, graphite, etc. In an. embodiment, the grounding ring may comprise rows of conductive microfibers such as in the FiberLock™ grounding ring available from AEGIS Manufacturing Company. The rotor may be formed of a non-electrically conductive material such as plastic. However, the rotor also may be formed of an electrically conductive material such as steel, aluminum, bronze, or the like. The housing 5 is formed of an electrically conductive material such as bronze, steel, aluminum, or the like. The electrically conductive adhesive 92 is a bonding adhesive, such as AEGIS™ EP 2400, which is available from AEGIS Manufacturing Company. This adhesive is a two-part epoxy as is known in the art.

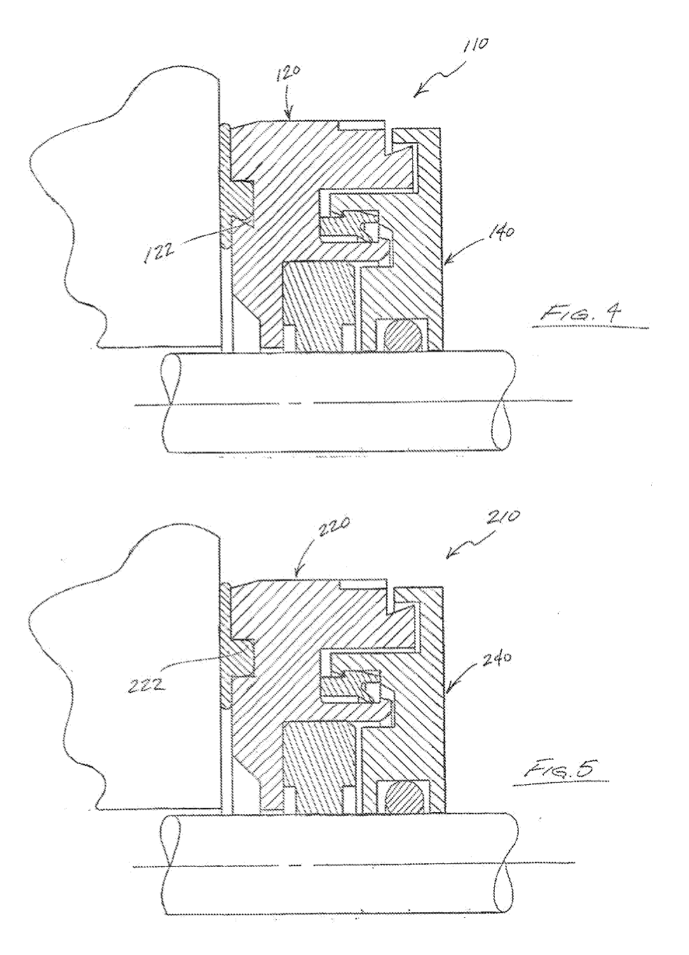

FIGS. 4 and 5 illustrate alternative embodiments of the seal assembly. In particular, the stators shown in FIGS. 4 and 5 include axial grooves for receiving the adhesive, each of which are of a different configuration than that shown in FIG. 1. For example, in FIG. 4, axial groove 122 is a half dovetail groove. Also, as shown in FIG. 5, the axial groove 222 may be an O-ring groove 222. Other non-geometric shapes and geometric shapes are possible.

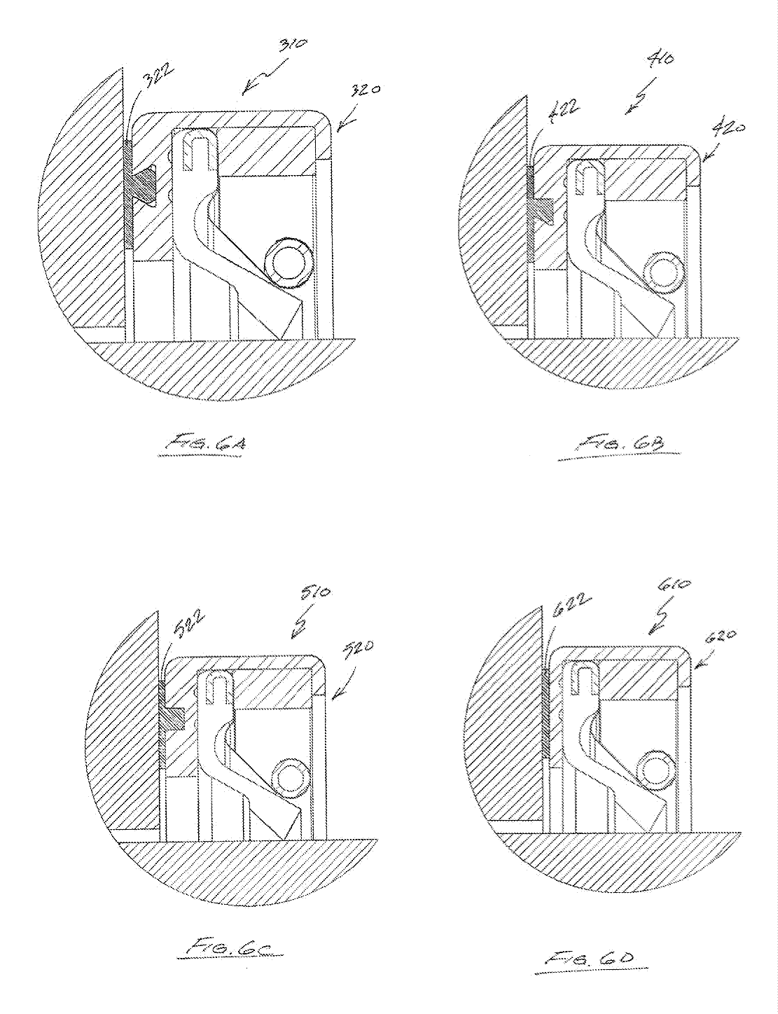

While the embodiments shown in FIGS. 1-5 are directed to a combination seal and grounding ring assembly, other seal types may include an axial face groove for receiving an adhesive, whether it is electrically conductive or not. As shown in FIG. 6A, a seal assembly 310 according to a fourth exemplary embodiment includes a sealing device 320 in the form of a lip seal. Lip seal 320 includes a dovetail groove as explained above that receives adhesive 322. FIGS. 6B and 6C illustrate fifth and sixth embodiments that include variations on the dovetail axial groove. FIG. 6D illustrates a seal assembly 610 according to a seventh exemplary embodiment that does not employ an axial adhesive groove. In this ease, the seal is secured to the housing with adhesive 622.

Also contemplated herein are methods of securing a seal to a housing incorporating the seal assemblies as described above. The methods may include the steps of providing a seal including an axial groove such as axial groove 22 on the stator 20 shown in, for example, FIGS. 1 and 2, applying an electrically conductive adhesive into the groove, and subsequently placing the axial face 23 of the stator 20 against the housing 5. Preferably, the method would include first cleaning the housing by removing paint, dirt, or other contaminants prior to applying the adhesive. Next, the seal ring 60 is engaged onto the stator and the grounding ring 84 is installed on the shaft 7 and urged into the counter bore 26. Next, the rotor 40 is installed against the stator 20, thereby engaging the seal ring 60 which in turn secures the rotor 40 to the stator 20. The method also may include the step of installing a shaft seal 82 on the rotor 40 prior to installation. Alternatively, the rotor 40, the stator 20, the seal ring 60, and the shaft seal 82 may be assembled and installed on the shaft as a unit. In an embodiment, existing seal assemblies may be retrofitted with the technology of the present application by removing the assembly and making an axial groove in the stator 20, such as by machining or the like. In an embodiment, the method may include forming a groove in the housing concentric with the shaft and applying adhesive in the housing groove.

Accordingly, the seal ring and the grounding ring apparatus along with the methods of securing the same have been described with some degree of particularity directed to the exemplary embodiments. It should be appreciated, however, that the present invention is defined by the following claims construed in light of the prior art so that modifications or changes may be made to the exemplary embodiments without departing from the inventive concepts contained herein.

What is claimed is:

1. An apparatus, comprising:
an electrically conductive stator including a groove formed in a face thereof;
a rotor mated with said stator, wherein said rotor includes a seal groove formed around an inner radius thereof and further comprising a rotor seal disposed in said seal groove;
a seal ring interposed between said stator and said rotor;
a grounding ring interposed between said stator and said rotor, wherein said grounding ring is electrically coupled to said stator; and
an electrically conductive adhesive for application into said groove and onto said face.

2. The apparatus according to claim 1, wherein said, groove is selected from one of a square groove, a dovetail groove, and a half dovetail groove.

3. The apparatus according to claim 1, wherein said adhesive is an electrically conductive two-part epoxy.

4. The apparatus according to claim 1, wherein said stator engages said seal ring around an inner circumference of said seal ring and said rotor engages said seal ring around an outer circumference of said seal ring.

5. A motor having a housing and a shaft, comprising;
an electrically conductive stator including a groove formed in a face thereof attached to the housing around the shaft;
a rotor disposed on the shaft and mated with said stator, wherein said rotor includes a seal groove formed around an inner radius thereof and further comprising a rotor seal disposed in said seal groove and adjacent the shaft;
a seal ring interposed between said stator and said rotor; and
a grounding ring interposed between said stator and said rotor, wherein said grounding ring is electrically coupled to said stator and the shaft.

6. The motor according to claim 5, wherein said stator is attached to the housing with an electrically conductive adhesive disposed in said groove and on said face.

7. The apparatus according to claim 6, wherein said groove is selected from one of a square groove, a dovetail groove, and a half dovetail groove.

8. The apparatus according to claim 5, wherein said stator engages said seal ring around an inner circumference of said seal ring and said rotor engages said seal ring around an outer circumference of the seal ring.

9. A method of securing a seal to a housing, comprising:
providing a seal having a groove formed in a face thereof;
applying adhesive into said groove and onto said face; and
placing said face against the housing.

10. The method according to claim 9, wherein said groove is selected from one of a square groove, a dovetail groove, and a half dovetail groove.

11. The method according to claim 9, wherein said adhesive is electrically conductive.

12. The method according to claim 9, further providing a seal that includes an isolator ring and wherein said adhesive is conductive.

13. The method according to claim 9, further comprising cleaning the housing prior to placing said face against the housing.

14. The method according to claim 9, wherein said seal is a labyrinth seal.

15. A method of providing a seal between a housing and a shaft, comprising:
providing a stator having a groove formed in a face thereof;
applying adhesive into said groove and onto said face;
installing said stator around the shaft and placing said face against the housing;
engaging a seal ring into said stator; and
mating a rotor with said stator such that said rotor engages said seal ring.

16. The method according to claim 15, further comprising installing a rotor seal around the inner radius of said rotor.

17. The method according to claim 15, wherein the step of engaging a seal ring into said stator is performed before placing said face against the housing.

18. The method according to claim 17, wherein the step of mating a rotor with said stator is performed before placing said face against the housing.

19. The method according to claim 15, further comprising cleaning the housing prior to placing said face against the housing.

20. The method according to claim 15, wherein said groove is selected from one of a square groove, a dovetail groove, and a half dovetail groove.

21. The method according to claim 15, further comprising installing a grounding ring between said stator and the shaft.

22. The method according to claim 21, wherein said adhesive is an electrically conductive two-part epoxy.
